(19) United States
(12) Patent Application Publication
(10) Pub. No.: US 2016/0364280 A1
(43) Pub. Date: Dec. 15, 2016

(54) CIRCUITRY AND METHOD FOR TESTING AN ERROR-CORRECTION CAPABILITY

(71) Applicant: Infineon Technologies AG, Neubiberg (DE)

(72) Inventor: Martin Perner, Muenchen (DE)

(21) Appl. No.: 15/176,679

(22) Filed: Jun. 8, 2016

(30) Foreign Application Priority Data
Jun. 10, 2015 (DE) 10 2015 210 651.9

(51) Int. Cl. G06F 11/07

(52) U.S. Cl. CPC G06F 11/079; G06F 11/0706; G06F 11/0751

(57) ABSTRACT

A circuitry for error-correcting data and for checking a correctness of an error-correction capability of an error-correction component of the circuitry is provided. The circuitry includes an input interface for receiving an input data word. Moreover, the circuitry includes a data manipulator for manipulating one or more bits of a test data word to obtain a modified data word, wherein said test data word is said input data word or is derived from said input data word. Furthermore, the circuitry includes said error-correction component for processing the modified data word. Moreover, the circuitry includes an evaluation component for evaluating the correctness of the error-correction capability of the error-correction component depending on the processing of the modified data word by the error-correction component.

### CROSS REFERENCE TO RELATED APPLICATION

This application claims priority to German Patent Application number 102 015 210 651.9 filed Jun. 10, 2015, which is hereby incorporated by reference in its entirety.

### FIELD

The present invention provides concepts for testing an error-correction-code-circuitry of a memory during operation without the need for error-free test data.

### BACKGROUND

In the prior art, known defective test data is generated for checking the correct execution of error correction of single-bit-errors or double-bit-errors in a (non-volatile) flash memory by employing an incorrect error correction code as test code (by double programming). Inter alia, this method has the following disadvantages:

A respective memory portion must be tested in advance to confirm that it is error-free. Memory portions which are assumed to be inherently error-free cannot be used for the test code, as the exact knowledge of single-bit-errors and double-bit-errors that are expected can otherwise not be used for assessing the error correction code functioning.

If, in addition, a column-oriented burst length error is involved, then, in operation, the test code is unintentionally disturbed. If the test software does not handle the disturbed test code in an error-tolerant way, the component creates an unintended error signal.

To circumvent the standard error handling, either the strict error detection algorithm is relaxed or alternative memory portions are specified, which are also tested for majority determination. A resulting disadvantage is that further memory portions have to be allocated for the multi-comparison.

Furthermore, in the prior art, the user is not provided with means for programming data and error correction code separately in a concrete erroneous way. The test code exhibiting a single-bit-error or a double-bit-error is instead only programmable in user mode. At present, in the case of non-volatile memory, such as a flash memory, the component is programmed twice in user mode and by this, the error correction codes are associated as if an OR operation would be conducted (double programming without prior deletion). As such a proceeding is not allowed by the component, it has not been tested, whether such an operation is working properly. Moreover, in volatile memories it is also not possible to configure within one ECC word the ECC content independent from the data content without allowing modifying the ECC.

To test all data bits for error-correction-code error detection, a dedicated memory portion is programmed and then a second suitable code is double-programmed. The data is selected such that a double programming does not modify the error-correction-code content in an undesired way and, except from the intended bit deviations, the result is equal to the initial programming.

Moreover, the multi-programming of the error-correction test code may be complicated by address error correction code employment. When using an address error correction code, in addition to the data, the address of the data is also used for the error correction code calculation. It is thus possible to detect an erroneously addressed but correct error-correction-code memory content. In this case, the address-independent error correction test code is dependent on the memory portion and no longer flexibly useable.

Furthermore, in the prior art, the test code is preset by the manufacturer. The user is not provided with means to select the error correction code words by himself. Auxiliary means or the possibility to determine a user data word for an error correction code word (user data and error-correction-code byte) for an error correction code word and for a predefined error correction code data word are not provided.

It would be highly beneficial if improved concepts for testing an error-correction-code circuitry would be provided.

### SUMMARY

A circuitry for error-correcting data and for checking a correctness of an error-correction capability of an error-correction component of the circuitry is provided. The circuitry comprises an input interface for receiving an input data word. Moreover, the circuitry comprises a data manipulator for manipulating one or more bits of a test data word to obtain a modified data word, wherein said test data word is said input data word or is derived from said input data word. Furthermore, the circuitry comprises said error-correction component for processing the modified data word. Moreover, the circuitry comprises an evaluation component for evaluating the correctness of the error-correction capability of the error-correction component depending on the processing of the modified data word by the error-correction component.

Moreover, a method for error-correcting data and for checking a correctness of an error-correction capability of an error-correction component is provided. The method comprises receiving by an input interface an input data word, manipulating by a data manipulator one or more bits of a test data word to obtain a modified data word, wherein said test data word is said input data word or is derived from said input data word, processing the modified data word by said error-correction component. and:evaluating by an evaluation component the correctness of the error-correction capability of the error-correction component depending on the processing of the modified data word by the error-correction component.

Furthermore, a computer program for implementing the above-described method when being executed on a computer or signal processor is provided. Furthermore, a non-transitory digital storage medium comprising the computer program for implementing the above-described method when being executed on a computer or processor is provided.

Before embodiments of the present invention are described in detail using the accompanying figures, it is to be pointed out that the same or functionally equal elements are given the same reference numbers in the figures and that a repeated description for elements provided with the same reference numbers is omitted. Hence, descriptions provided for elements having the same reference numbers are mutually exchangeable.

### BRIEF DESCRIPTION OF THE DRAWINGS

FIG. 1 illustrates a circuitry for error-correcting data and for checking a correctness of an error-correction capability of an error-correction component of the circuitry according to an embodiment;

FIG. 2 illustrates a circuitry according to an embodiment, wherein the error-correction component is arranged to receive the input data word from the input interface;

FIG. 3 illustrates a circuitry according to an embodiment, wherein the circuitry furthermore comprises a mode switcher for activating a normal operation mode;

FIG. 4 illustrates a circuitry according to an embodiment, wherein the circuitry, in addition to the components of FIGS. 1 to 3, furthermore comprises a user interface;

FIG. 5 illustrates a circuitry according to an embodiment, wherein the test data word may comprises the user data bits, the error-correction bits and address bits for specifying a location of the user data bits within a memory;

FIG. 6 illustrates a circuitry according to an embodiment, wherein the circuitry itself furthermore comprises a memory;

FIG. 7 illustrates a circuitry according to a particular embodiment, wherein the circuitry comprises the memory and a user interface for specifying one or more addressable bits indicated by an address within the memory that shall be modified. The address is explicitly applied or implicitly referenced;

FIG. 8 illustrates a data manipulator according to an embodiment, wherein the data manipulator comprises an circuit element, a further circuit element, and a bit register. The data manipulator in FIG. 8 has a one-stage XOR. Single bit modifications like shift or rotate can be applied before in a separate stage. According to some embodiments, both bit manipulation steps may, e.g., be included in a two stage manipulation, as depicted in FIGS. 18, 19 and 20;

FIG. 9 illustrates an error correction code memory according to embodiments with random access by a read path and a write path;

FIG. 10 illustrates an error correction code circuitry realized in a data path between a CPU and a memory. Moreover, the address registers employed are depicted.

FIG. 11 illustrates a small register set extension for supporting the circuitry correction check during operation;

FIG. 12 illustrates a flow diagram for initializing, operating and evaluating the functioning of the error correction capability for an intentionally double-programmed flash memory exhibiting error correction code capability;

FIG. 13 illustrates a flow diagram for manually checking an error-correction-code functioning;

FIG. 14 illustrates a flow diagram for semi-automatically checking an error-correction-code functioning;

FIG. 15 illustrates a flow diagram for continuously checking a functioning of the error correction code completely automatically;

FIG. 16 illustrates a register set for continuously checking an error-correction-code functioning completely automatically;

FIG. 17 illustrates an error-correction-code functionality check;

FIG. 18 illustrates a hardware implementation according to an embodiment;

FIG. 19 illustrates tree procedures of configuration (intialization, activation, autonomous monitoring) of an error-correction-code test finite state machine according to an embodiment; and

FIG. 20 illustrates an example depicting forcing and counting single bit errors and double bit errors according to an embodiment.

### DETAILED DESCRIPTION

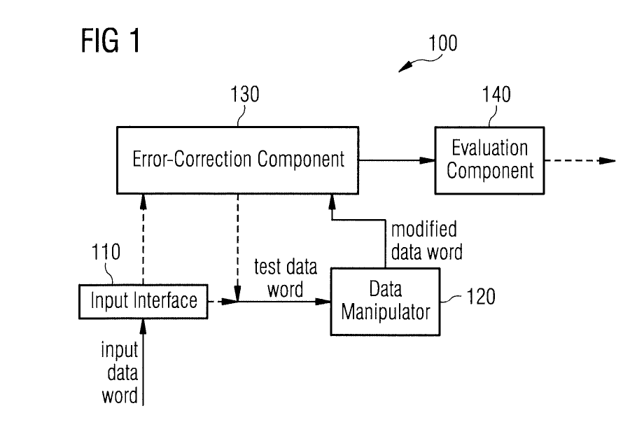

FIG. 1 illustrates a circuitry 100 for error-correcting data and for checking a correctness of an error-correction capability of an error-correction component 130 of the circuitry 100 according to an embodiment.

The circuitry 100 comprises an input interface 110 for receiving an input data word.

Moreover, the circuitry 100 comprises a data manipulator 120 for manipulating one or more bits of a test data word to obtain a modified data word, wherein said test data word is said input data word or is derived from said input data word.

Furthermore, the circuitry 100 comprises said error-correction component 130 for processing the modified data word.

Moreover, the circuitry 100 comprises an evaluation component 140 for evaluating the correctness of the error-correction capability of the error-correction component 130 depending on the processing of the modified data word by the error-correction component 130.

A purpose of the data manipulator 120 is that specific errors can be purposely created in the modified data word. Assuming that the test data word is error-free, modifying one bit of the test data word creates a modified data word that exhibits exactly a single-bit-error. It can then be evaluated by the evaluation component 140 whether the error-correction code correctly processes the modified data word.

In some embodiments, the evaluation unit 140 may, e.g., be configured to deactivate the circuitry 100 or to output an alarm or alarm message, if the evaluation component 140 has detected that the error-correction of the error-correction component 130 is incorrect.

In different embodiments, different criteria of evaluating a correct processing of the error-correction component are applied.

According to one embodiment, the evaluation component 140 considers a processing of the error-correction component as correct, if the error-correction component correctly detects that a modified data word exhibits an error, and if the error-correction component correctly corrects that error of that data word.

Such an embodiment has the advantage that not only error-detection but also error-correction of the error-correction component is checked.

In another embodiment, the evaluation component 140 considers a processing of the error-correction component as correct, if the error-correction component correctly detects that a modified data word exhibits an error, and does not test whether a correction of the modified data word would be successful. In some of such embodiments, the error-correction circuit does not correct the modified data word, but does only determine, whether a correction of the modified data word is necessary.

Such an embodiment has the advantage that processing time is saved that would be necessary for correcting the modified data word. Inter alia, this allows that a large number of modified data words exhibiting different modifications can be tested for correct error-detection in shorter time compared to embodiments, where also the correct error-correction is tested. An underlying assumption of such embodiments is that error-correction will be correctly conducted by the error-correction component 130 as long as all errors that shall be detected are really detected.

As outlined above, according to some embodiments, it is tested whether the result of the error correction is correct. In some embodiments, if a correction took place, a single bit error indicator or a double bit error indicator may, for example, be set.

According to a further embodiment, the error-correction component 130 may, for example, be configured to check whether the modified data word is erroneous. If the error-correction component 130 has determined that the modified data word is erroneous, the error-correction component 130 may, e.g., be configured to correct the modified data word to obtain a corrected data word comprising user data bits and error-correction bits. The evaluation component 140 may, e.g., be configured to determine depending on the user data bits of the corrected data word and depending on the error-correction bits of the corrected data word, whether the corrected data word is erroneous. If the corrected data word is erroneous, the evaluation component 140 is configured to determine that the error-correction capability of the error-correction component 130 is incorrect.

Thus, after conducting a correction of a detected error, another test is conducted to determine, whether an error is present in the corrected data word. If the conducted correction was successful, no error should be present in the corrected data word. Otherwise, it is determined the error-correction component 130 is incorrect.

Modifying a bit of a test data word may, e.g., be conducted by inverting the test data word, for example, by changing a bit value from “0” to “1” or by changing a bit value from “−1” to “0”.

According to an embodiment, the error-correction component 130 may, e.g., be configured to check (and may, for example, be configured to indicate by flagging) whether the modified data word is erroneous. In such an embodiment, the evaluation component 140 may, e.g., be configured to evaluate the correctness of the error-correction capability (e.g., error flagging and/or applied data correction) of the error-correction component 130 depending on the outcome of the check, conducted by the error-correction component 130, whether the modified data word is erroneous.

According to an embodiment, the error-correction component 130 may, e.g., be configured to check whether the modified data word is erroneous. In such an embodiment, if the error-correction component 130 has determined that the modified data word is erroneous, the error-correction component 130 may, e.g., be configured to correct the modified data word to obtain a corrected data word. Moreover, in such an embodiment, the evaluation component 140 may, e.g., be configured to determine, whether the corrected data word is equal to an expected data word. Furthermore, in such an embodiment, if the corrected data word is different from the expected data word, the evaluation component 140 may, e.g., be configured to determine that the error-correction capability of the error-correction component 130 is incorrect.

In other embodiments, the test data word, itself, may be fed into the error-correction component 130 without modification. The evaluation component 140 may consider the error-correction component 130 to be erroneous, if the error-correction component 130 considers the test data word erroneous, while in fact, the test data word is error-free.

In more general, in some embodiments, an error-free data word may, e.g., be fed into the error-correction component 130. The evaluation component 140 may consider the error-correction component 130 to be erroneous, if the error-correction component 130 considers the error-free data word as erroneous.

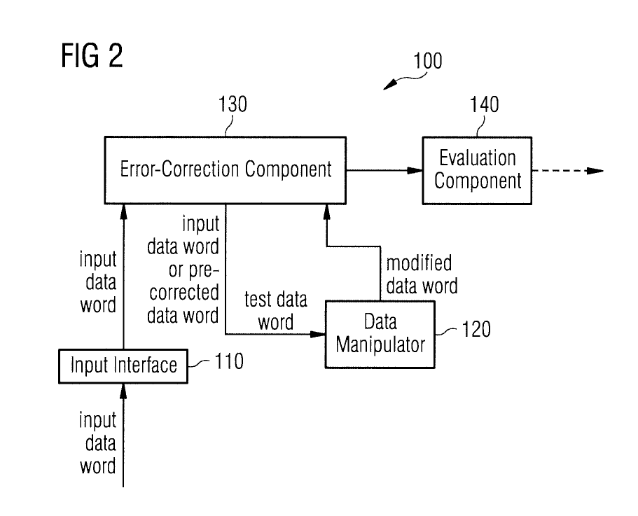

FIG. 2 illustrates a circuitry 100 according to an embodiment, wherein the error-correction component 130 is arranged to receive the input data word from the input interface 110. In such an embodiment, the error-correction component 130 may, e.g., be configured to check, whether the input data word is erroneous.

If, in FIG. 2, the error-correction component 130 determines that the input data word is erroneous, the error-correction component 130 may, e.g., be configured to correct the input data word to obtain a precorrected data word and may, e.g., be configured to feed the precorrected data word as said test data word into the data manipulator 120.

If the error-correction component 130 determines that the input data word is not erroneous, the error-correction component 130 may, e.g., be configured to feed the input data word as said test data word into the data manipulator 120.

The embodiment of FIG. 2 has inter alia the advantage, that, after the correctness of the input data has been checked by the error-correction component 130, and after possibly, correction of the input data word has been conducted, the likelihood increases that the test data word that is fed into the data manipulator is error-free.

An alternative embodiment to FIG. 2 directly feeds the input data word from the input interface 110 into the data manipulator 130. Such an embodiment has inter alia the advantage that no processing time is spent on checking and possibly correcting the input data word.

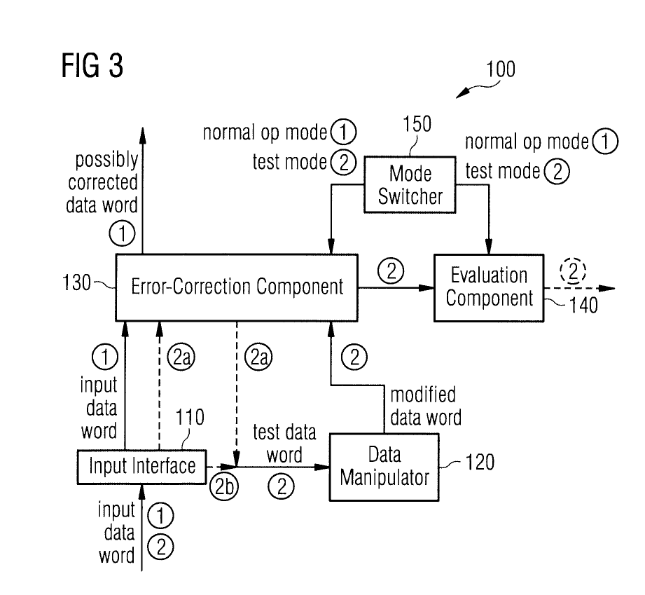

FIG. 3 illustrates a circuitry according to an embodiment, wherein the circuitry 100 furthermore comprises a mode switcher 150 for activating a normal operation mode. In such an embodiment, if the normal operation mode is activated, the mode switcher 150 is configured to deactivate the data manipulator 120 and the evaluator, so that, when the normal operation mode is activated, the data manipulator 120 may, e.g., be configured to not manipulate said one or more bits of said test data word, and so that, when the normal operation mode is activated, said evaluation component 140 may, e.g., be configured to not evaluate the correctness of the error-correction capability of the error-correction component 130.

In particular, FIG. 3 illustrates a normal operation mode, indicated by “1” and a test mode, indicated by “2”. In FIG. 3, in the normal operation mode, an input data word is fed from the input interface 110 to the error-correction component 130, where the input data word is checked for correctness and corrected, if necessary. The (possibly corrected) data word is then output by the error-correction component 130.

In test mode, indicated by “2” in FIG. 3, the circuitry 100 operates as described with reference to FIGS. 1 and 2.

In preferred embodiments. Two modes of operations exists, for example, a normal operation mode and a test mode. Test mode is only activated, at times where the error-correction component or a processor is not processing data.

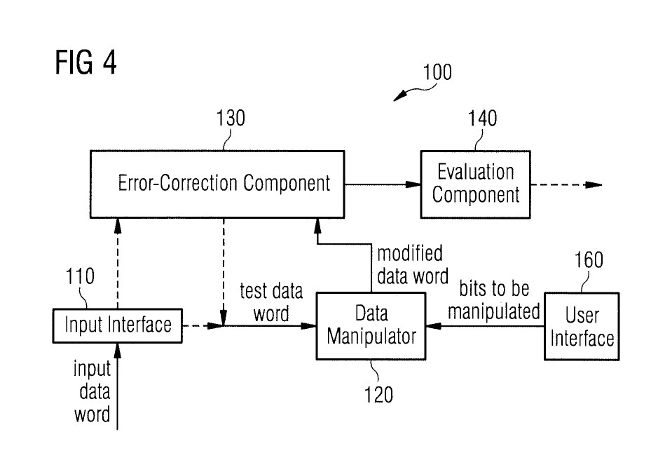

FIG. 4 illustrates a circuitry 100 according to an embodiment, wherein the circuitry 100, in addition to the components of FIGS. 1 to 3, furthermore comprises a user interface 160 being configured to enable a user to specify one or more bits of the test data word that shall be manipulated. In such an embodiment, the data manipulator 120 may, e.g., be configured to manipulate said one or more bits of the test data word that have been specified by the user via the user interface 160.

In contrast to prior art, the user does not have to rely on predetermined test procedures, but can himself specify how to modify the test data word to create specific bit errors that he wants to test. An individualization of the test to the specific requirements of the user becomes possible.

In an embodiment, the test data word may, e.g., comprise user data bits and error-correction bits for error-correction. In such an embodiment, the data manipulator 120 may, e.g., be configured to manipulate at least one bit of the error-correction bits of the test data word.

It is thus not only possible to test modified data words with erroneous user data but it becomes possible to also test modified data words comprising erroneous error-correction bits.

According to an embodiment, the circuitry 100 the user interface 160 may, e.g., be configured to enable a user to specify said at least one bit of the error-correction bits of the test data word. In such an embodiment, the data manipulator 120 may, e.g., be configured to manipulate said at least one bit of the error-correction bits of the test data word that has been specified by the user via the user interface 160.

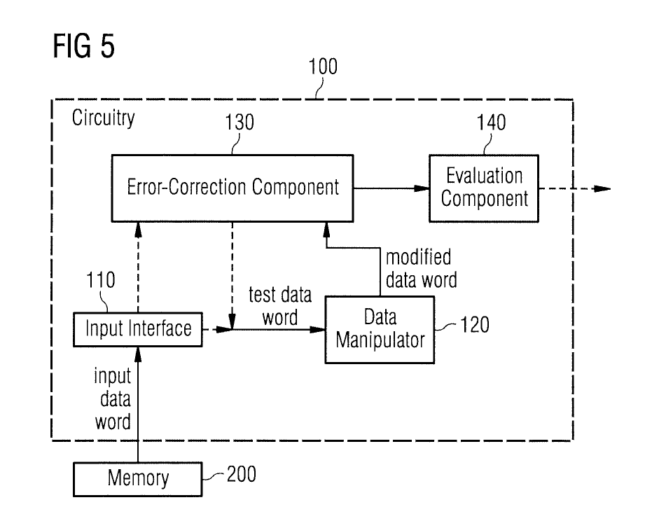

FIG. 5 illustrates a circuitry 100 according to an embodiment, wherein the test data word may, e.g., comprise the user data bits, the error-correction bits and address bits for specifying a location of the user data bits within a memory 200. In such an embodiment, the data manipulator 120 may, e.g., be configured to manipulate at least one bit of the address bits of the test data word.

According to an embodiment, the user interface 160 may, e.g., be configured to enable a user to specify said at least one bit of the address bits of the test data word. In such an embodiment, the data manipulator 120 may, e.g., be configured to manipulate said at least one bit of the address bits of the test data word that has been specified by the user via the user interface 160.

It is thus not only possible to test modified data words with erroneous user data or erroneous error-correction bits but it becomes possible to also test modified data words comprising erroneous address bits.

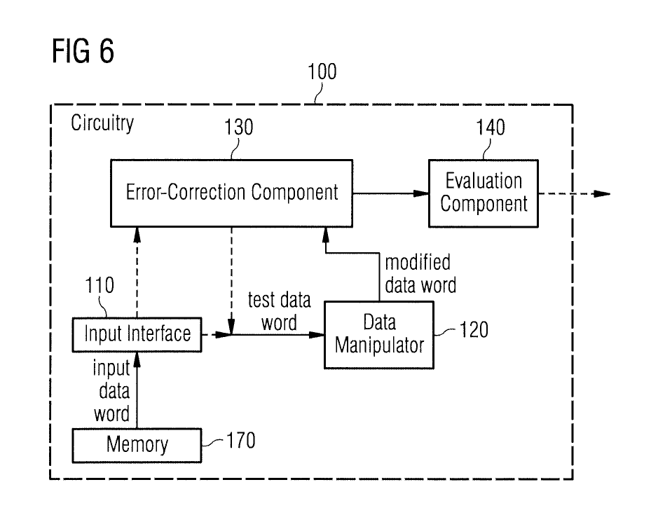

FIG. 6 illustrates a circuitry 100 according to an embodiment, wherein the circuitry 100 itself furthermore comprises a memory 170. In such an embodiment, the input interface 110 may, e.g., be configured to load the input data word from the memory 170.

In an embodiment, said memory 170 may, e.g., be a flash memory or any other kind of non-volatile memories.

In general, in the flash memory itself, the bits of the flash memory can only be changed from a specific first bit value to a specific second bit value, but not from the specific second bit value to the specific first bit value. (For example, in a particular example, in a particular flash memory, the bit value “0” is changeable to the bit value “1” during program operation, but the bit value “1” is not changeable to the bit value “0” without erase operation). Embodiments do not change the flash value itself but generate one or more modified data words outside the flash memory. Therefore, arbitrary changes of the bits values from “0” to “1” and also from “1” to “0” are possible.

In an embodiment, the test data word may, e.g., comprise the user data bits and the error-correction bits, and address bits for specifying a location of the user data bits within the memory 170 of the circuitry 100 as described above for the memory 200. In such an embodiment, the data manipulator 120 may, e.g., be configured to manipulate at least one bit of the address bits of the test data word.

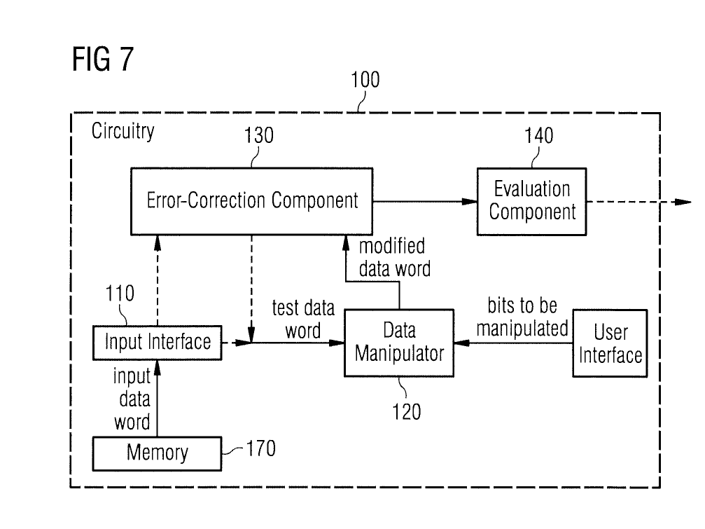

FIG. 7 illustrates a circuitry 100 according to a particular embodiment, wherein the circuitry 100 comprises the memory 170 and the user interface 160 for specifying one or more address bits indicating an address within the memory 170 of the circuitry 100 that shall be modified.

According to an embodiment, the data manipulator 120 may, e.g., be configured generate two or more modified data words, said modified data word being one of the two or more data words, so that each modified data word of the two or more modified data words is different from each other modified data word of the two or more modified data words. In such an embodiment, the data manipulator 120 may, e.g., be configured to generate each of the two or more modified data words by modifying at least one bit of the test data word. Moreover, in such an embodiment, for each modified data word of the two or more modified data words, the error-correction component 130 may, e.g., be configured check whether said modified data word is erroneous. Furthermore, in such an embodiment, the evaluation component 140 may, e.g., be configured to evaluate the correctness of the error-correction capability of the error-correction component 130 depending on the outcome of the checking of the two or more modified data words.

In an embodiment, the evaluation component 140 may, e.g., be configured to determine an erroneous words number indicating how many modified data words of the two or more modified data words the error-correction component 130 assesses to be erroneous. In such an embodiment, the evaluation component 140 may, e.g., be configured to determine whether said erroneous words number is equal to an expected error number indicating how many of the two or more modified data words are actually erroneous.

According to an embodiment, the data manipulator 120 may, e.g., be configured to generate each of the two or more modified data words by modifying exactly one bit of the test data word.

Such an embodiment tests modified data words with exactly one-bit error (single bit error), under the assumption that the test data word is error-free.

In an embodiment, the data manipulator 120 may, e.g., be configured to generate each of the two or more modified data words by modifying exactly two bits of the test data word.

Such an embodiment tests modified data words with exactly two-bit errors (double bit errors), under the assumption that the test data word is error-free.

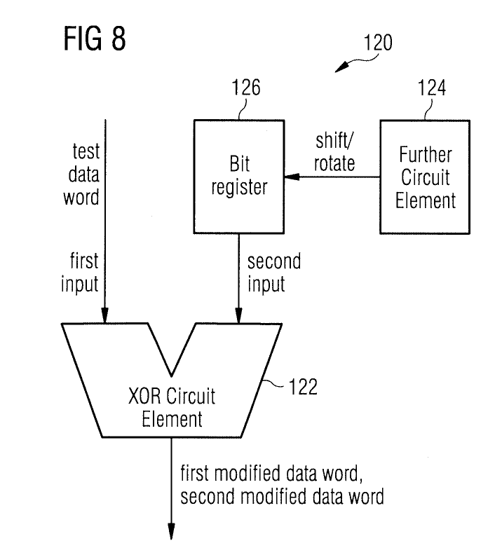

FIG. 8 illustrates the data manipulator 120 according to an embodiment, wherein the data manipulator comprises an XOR circuit element 122, a further circuit element 124, and a bit register 126.

In such an embodiment, the bit register 126 may, e.g., comprise a bit for each bit position of the test data word. Moreover, in such an embodiment, the bit register 126 may, e.g., be configured, so that each bit in the bit register 126, being assigned to a bit position of the test data word, that is to be inverted to generate a first modified data word of the two or more modified data words, exhibits a first bit value in the bit register 126. Furthermore, in such an embodiment, the bit register may, e.g., be configured, so that each bit in the bit register, being assigned to a bit position of the test data word that is not to be inverted to generate the first modified data word, exhibits a second bit value in the bit register 126, said second bit value being different from the first bit value.

Moreover, in such an embodiment, the XOR circuit element 122 may, e.g., be arranged to receive the test data word as a first input. Furthermore, in such an embodiment, the XOR circuit element 126 may, e.g., be arranged to receive the bit values of the bits in the bit register 126 as an initial second input to generate the first modified data word of the two or more modified data words.

Moreover, in such an embodiment, the further circuit element 124 may, e.g., be configured to shift or rotate the bit values of the bits within the bit register 126 by one bit position after the first modified data word has been generated to obtain updated bit values of the bits within the bit register 126. Furthermore, in such an embodiment, the XOR circuit element 122 may, e.g., be arranged to receive the updated bit values of the bits within the bit register 126 as an updated second input to generate a second modified data word of the two or more modified data words.

Such an embodiment is particularly suitable, for testing a plurality erroneous modified data words, by efficiently generating the plurality of modified data words.

Moreover, if, for example, rotation is employed for generating subsequent modified data words, it can be assumed that a bit error is shifted, but that in general, the number of bit errors stays the same in subsequent data words.

In the following, particular embodiments are described in detail.

According to embodiments, one or more user registers are provided for the user which allow the user to determine after reading out the test data, at which bit positions the error correction corrupts (inverts) the read result.

This happens by initializing an XOR-content which inverts the bit positions which exhibit value “1”. According to embodiments, an error correction test code is only programmed once error-free or at least error-correction-code correctable. The bit-wise modifiability of a possibly corrected, read test word could be conducted directly after reading the erroneous cell field without error correction code-correction as well as after a correction.

According to embodiments, corrupting the read data is preferably conducted circuitry-based immediately before the error-correction-code calculation of the read test data. In which way and at which bit positions the test data is modified is determined by a register set which is initialized before the testing of the error-correction-code calculation.

The purpose of using the error correction code test word is to selectively test the error-correction-code generation path after inserting a selective error in the error-correction-code logic on erroneously interpreted 0- or 1-bits. Preferably, the one or more bit switching means are generated in a controlled manner in a second stage, and afterwards the actively-started error correction code reaction is evaluated.

According to an embodiment, checking the error-correction-code capability may, for example, be conducted in four steps. In a first step, the error-correction-code test reading is initialized, for example, by determining in which way which bit of the test reading shall be inverted and, possibly, to which memory address the data is related to, in case of address error correction code. In a second step, a bit switching is conducted in the correctable error correction code word and the error-correction-code calculation is conducted for the just provoked correction step without again loading the data from the cell field. The reaction of the error correction on the previously loaded and bit-wise modified data is conducted in a last step with the usual registers and flags which are known by the user.

According to embodiments, a register set is provided which is assigned to an error correction code circuitry of a data bus to check an expected functioning of the error correction code circuitry. The error correction circuitry may be assigned to a volatile or non-volatile memory.

In an embodiment, loading from a programmable register set is conducted, and it is determined which of the bits of the user data, of the read address and of the error-correction-code data of the loaded error-correction-code data shall be modified.

According to an embodiment, modification of the bits to be modified may be conducted by setting one or more bits, deleting one or more bits, and/or inverting one or more bits.

In embodiments, it may optionally be determined whether in case of an address-error-correction-code calculation the address bits are also set, deleted and/or inverted in addition to the user- and error-correction-code data bits.

According to an embodiment, bit setting may be indicated which indicates that for a memory read access the test data and the read address have already been determined and that the next read access will not access said particular cell field.

According to an embodiment, it may optionally be determined whether a second read command with a bit manipulation without accessing the cell field shall be conducted immediately after the first one.

According to an embodiment, it may optionally be determined whether an error-flag signature shall be collected or loaded into a result register.

According to an embodiment, optionally, the occurrence of an error signature may be accumulated in an (e.g., initializable) counter register.

In embodiments, the error-correction-code functionality check and the evaluation of the error signature compared to an expected behavior may be conducted step-wise, semi-automatically and/or continually (possibly, e.g. by employing one or more interrupts).

Embodiments exhibit one, some or all of the following advantages: according to embodiments, the error-correction-code functionality of also non-volatile memories can be tested during operation, as an erroneous double-programming is not mandatory.

The memory component and the error-correction-circuitry do not have to be integrated on a single component. Each error-correction-code unit can conduct a self-test, where the unit tests itself.

An explicit memory allocation of the erroneous data is not necessary. In case of an address-error-correction-code method, the memory address does not have to be known and it is possible to determine freely selectable address sources. Multi-storage of the test data for a multi-comparison is not necessary.

In embodiments, the first reading may, e.g., be conducted with error-correction-code correction to conduct the memory error correction independent from the cell error correction possibility in an exact way even if additional cell errors occur.

If the first obtained read result is modified in a subsequent step for examination, then the second error-correction-code test read-out may be conducted with specific bit manipulation without additional latency (wait states).

If only a single register set is implemented for bit manipulation circuitry-wise, then the error-correction-code test read-out may be conducted with the same circuitry as the usual first readout. This results in a saving of space in the layout of the test circuitry, and also, the testing capability of the circuitry for error-correction-code test read-out itself does not require additional space.

No second error-correction-code circuitry is necessary which confirms the error-correction-code result in parallel and which itself would have to be checked during operation.

Optional further embodiments may, for example, conduct the error-correction-code test program controlled or automatically. If automatically conducting the functionality check, this could be conducted steered semi-automatically or continuously.

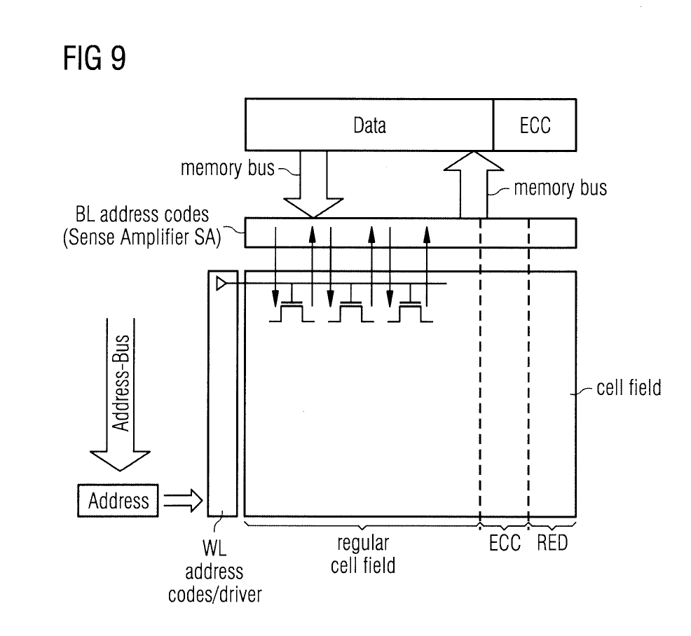

To illustrate a particular embodiment, FIG. 9 is provided, which, illustrates an error correction code memory according to an embodiment with random access by a read path and a write path.

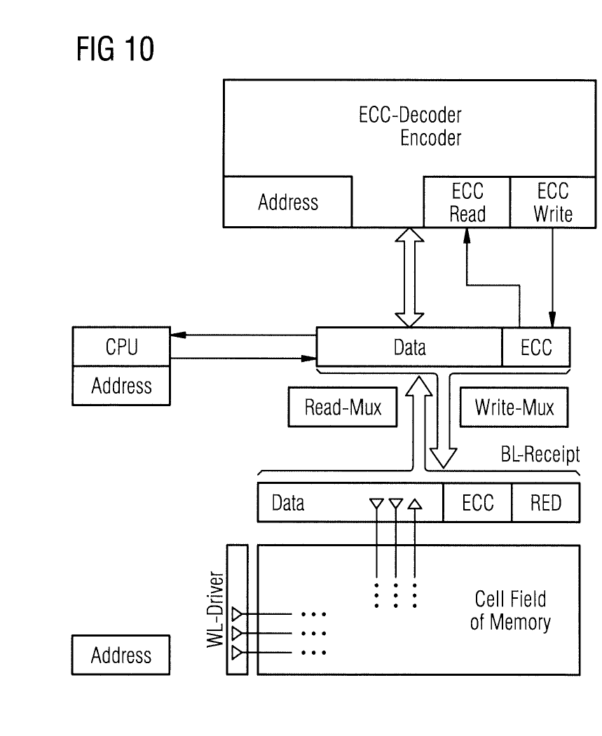

Moreover, FIG. 10 illustrates an error correction code circuitry realized in a data path between a CPU and a memory.

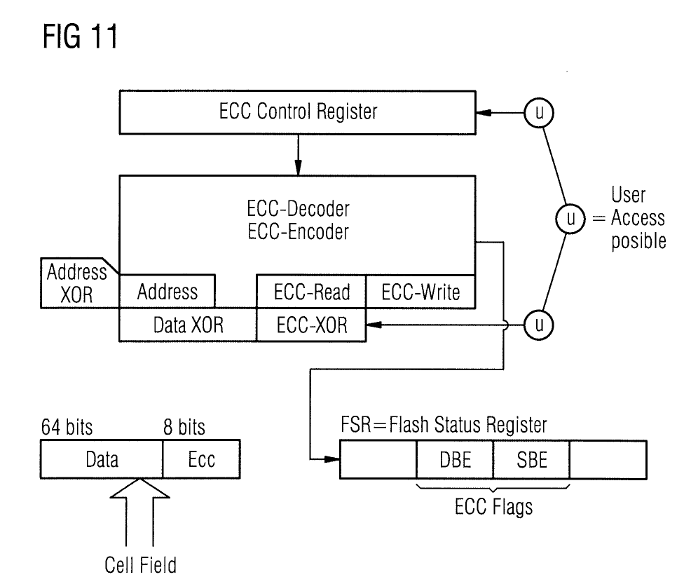

In FIG. 11 a small register set extension for supporting the circuitry correction check during operation according to an embodiment is depicted.

“Address XOR” may, e.g., be a 32 bit register for address bit inversion.

“ECCR XOR” may, e.g., be an 8 bit register for ECC read inversion (ECCR inversion).

“Data XOR” may, e.g., be a 64 bit register for data inversion.

“FSR” means flash status register.

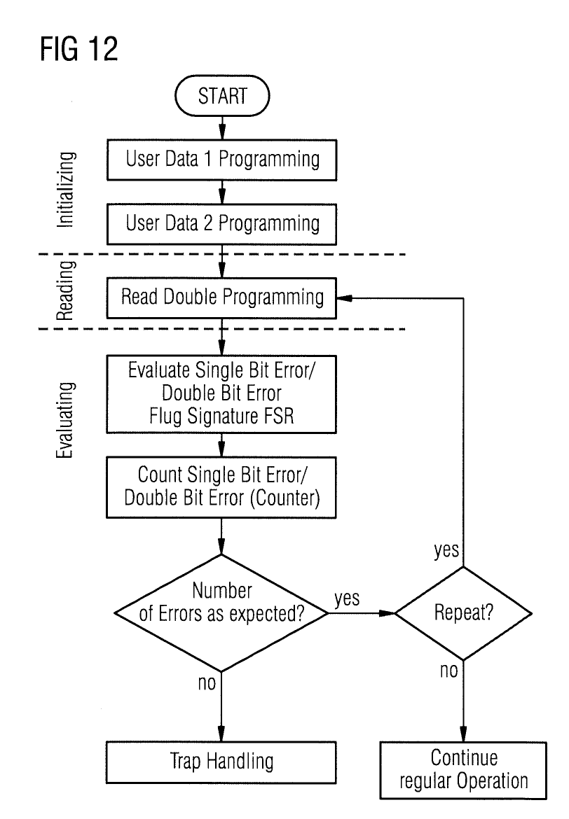

FIG. 12 illustrates a flow diagram for initializing, operating and evaluating the functioning of the error correction capability for an intentionally double-programmed flash memory exhibiting error correction code capability. In particular, FIG. 12 illustrates a usual double programming method.

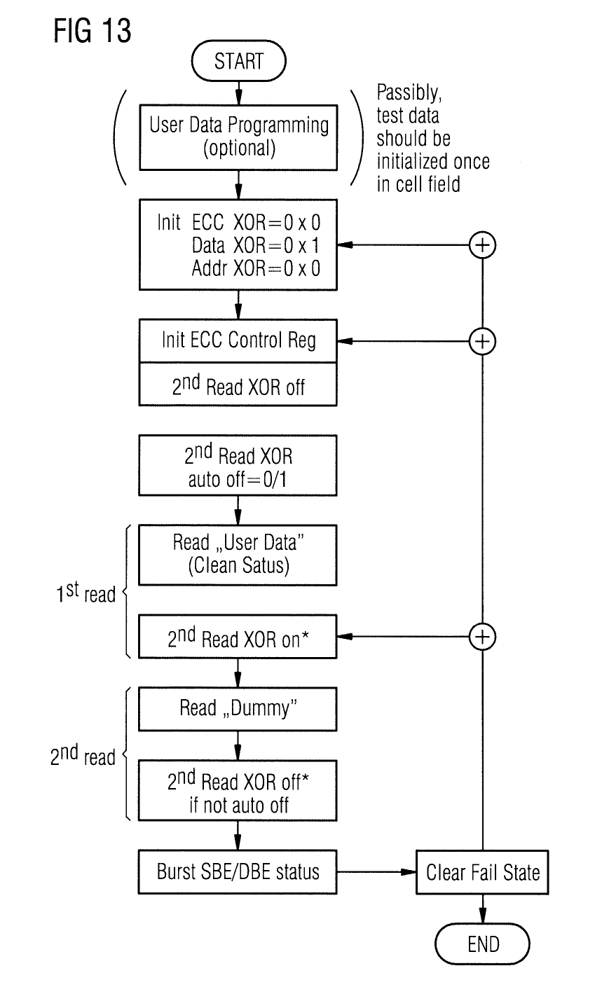

In FIG. 13 a flow diagram for manually checking an error-correction-code functioning according to an embodiment is depicted. In particular, FIG. 13 illustrates a manual single-bit response test (Status “CleaN” or “CleaR”?).

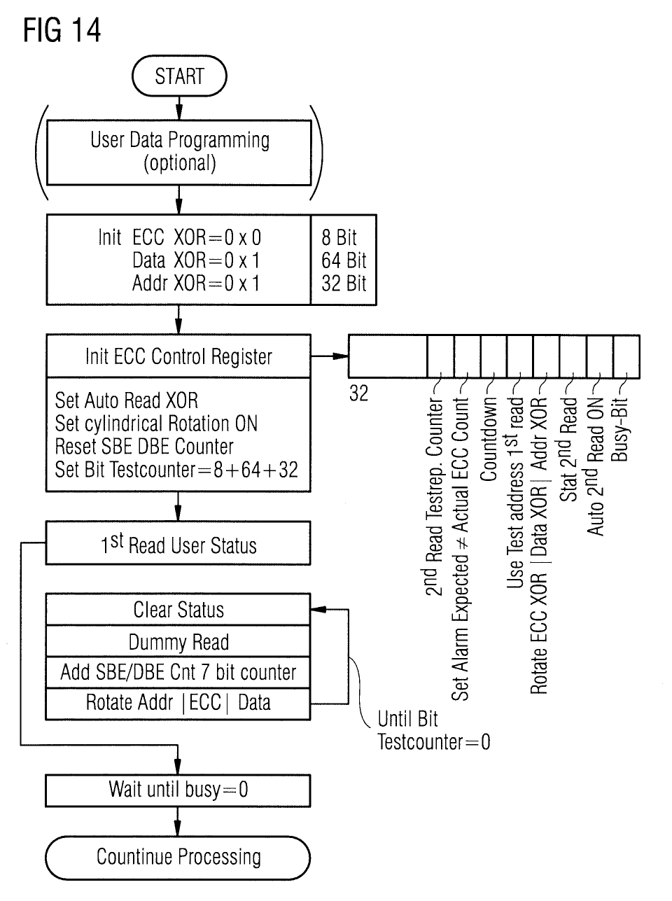

FIG. 14 illustrates a flow diagram for semi-automatically checking an error-correction-code functioning according to an embodiment. In particular, FIG. 14 illustrates a complete, single semi-automatic error-correction-code response test.

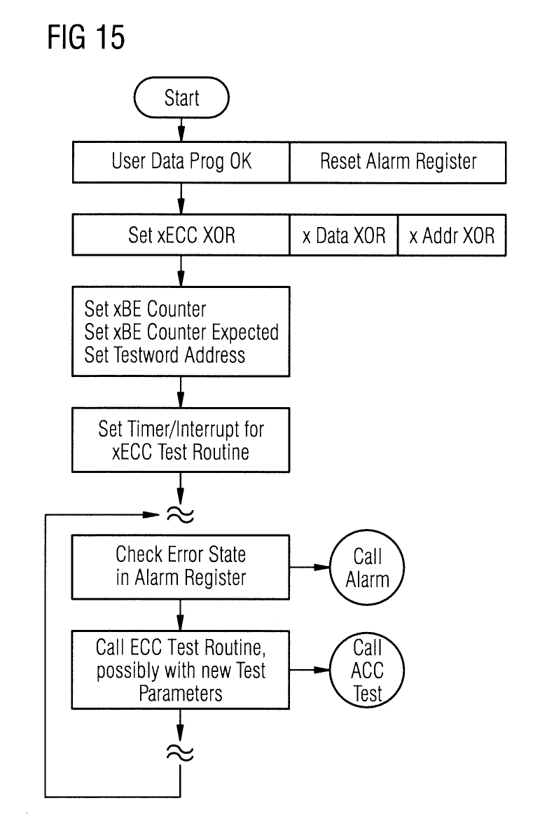

In FIG. 15 a flow diagram for continuously checking a functioning of the error correction code completely automatically is depicted. In particular, FIG. 15 illustrates an interrupt-steered continuous error-correction-code test routine.

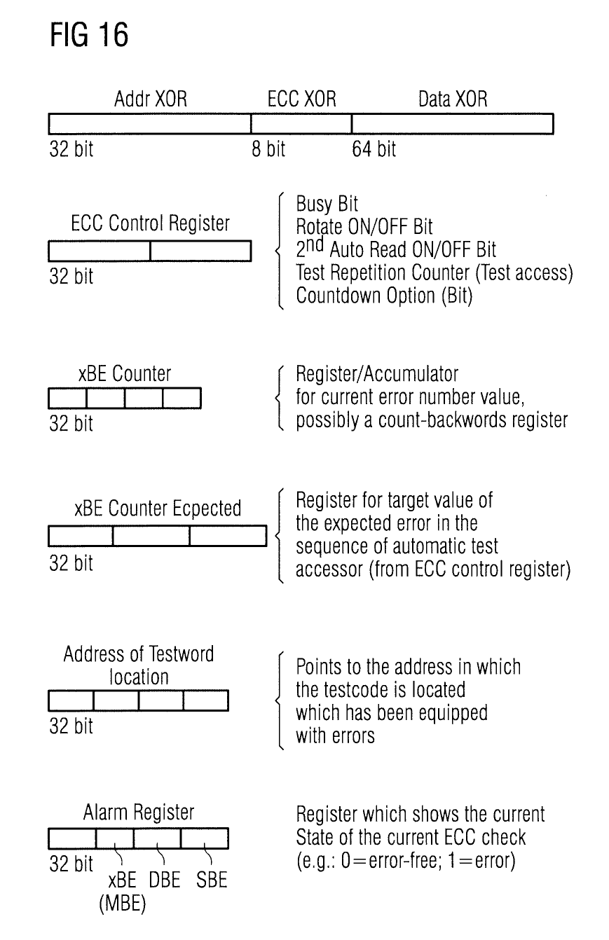

FIG. 16 illustrates a register set for continuously checking an error-correction-code functioning completely automatically according to an embodiment. In particular, FIG. 16 covers different error cases “X” (“X”: single bit error=SBE=S, double bit error=DBE=D, multi bit error=MBE=M).

In the following, further embodiments of the present invention are described in more detail. Before that, however, the state of the art is examined more closely.

In the state of the art, for conducting an error-correction-code functionality check, a customer needs confirmation about the error-correction-code functionality of the data path correction capabilities of the memory access at run time. An error-correction-code test is accomplished by processing specific, intentionally corrupted error-correction-code words. Said error-correction code words may have been derived from input data words that have been loaded from a memory, for example, from a flash memory.

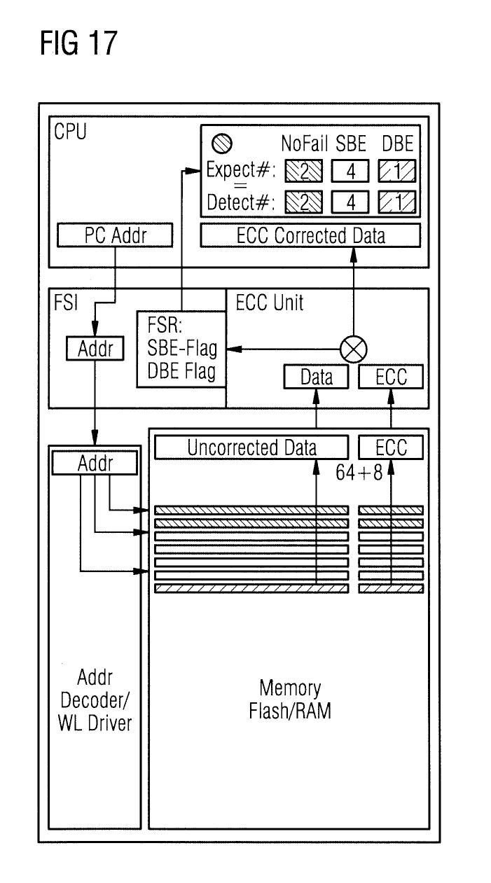

In eFlash, error-correction-code errors are artificially stored by double-programming without erasure (Forced Fail Signature). The detected error-flagging is compared against the expected error-flagging (“pass case”). This is illustrated in FIG. 17.

One problem is error-correction-code fail-count misinterpretation. Correctable memory bit failures lead to misinterpretation of unpredicted forced fail signatures due to single defects. Examples are, for example, single bit-flips and/or local/global burst length defects.

This means that unintentional bit-flips are influencing the signature of the expected error-correction-code fail flagging count signature.

An error-correction-code fail-signature change may occur.

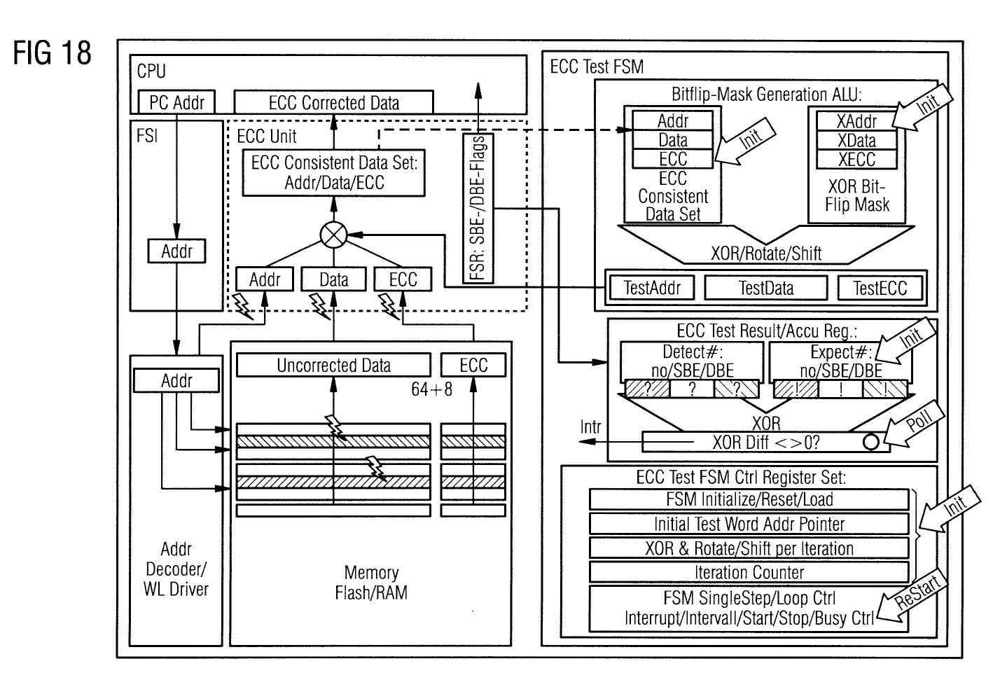

FIG. 18 illustrates a hardware solution according to an embodiment. A register set is provided to a customer to control the forced fail signature of an error-correction-code consistent data set (address/data/error correction code) obtained via the memory read path or by direct register setting.

During the read from the memory, any unpredicted correctable bit errors are error-correction-code-consistently-eliminated in the data set. The error-correction conducted may, e.g., be customer-specific.

The data set is used as a test pattern on which a bit-flip pattern can be applied in a single error-correction-code calculation step.

The bit-flip sequence can be iterated/automatized by a simplified state machine controlling the bit-flip pattern rotation and recording the bit error/double bit error events. The state machine is controlled by register set.

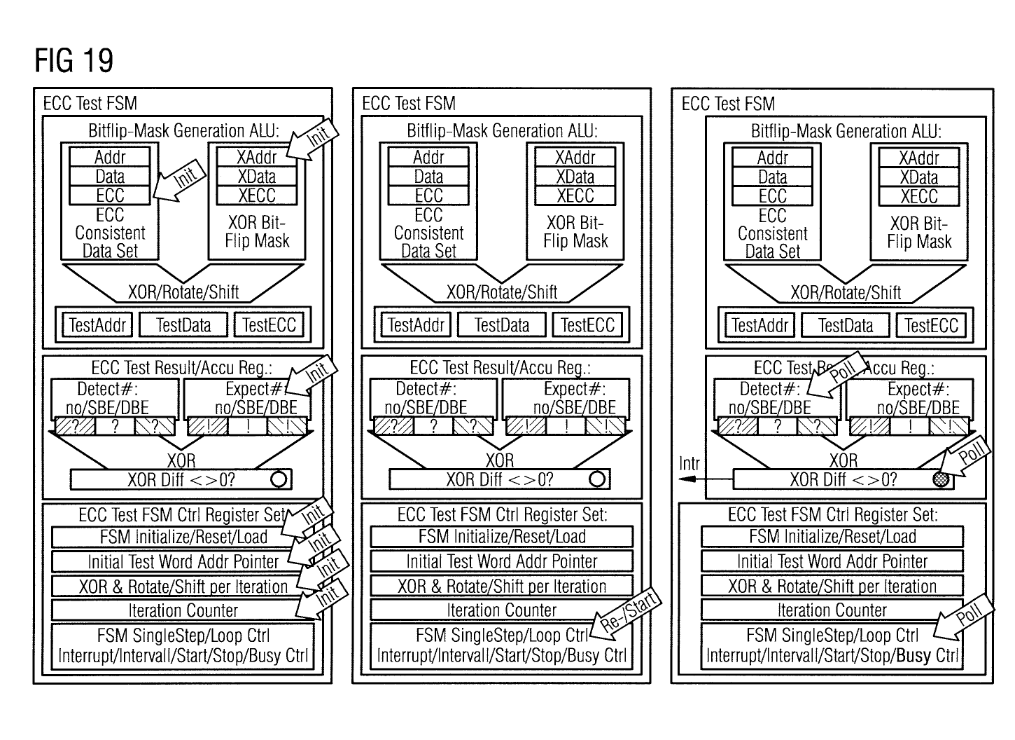

FIG. 19 illustrates another example according to an embodiment. Three steps of configuration may, for example, be possible: Initialization, activation, monitoring.

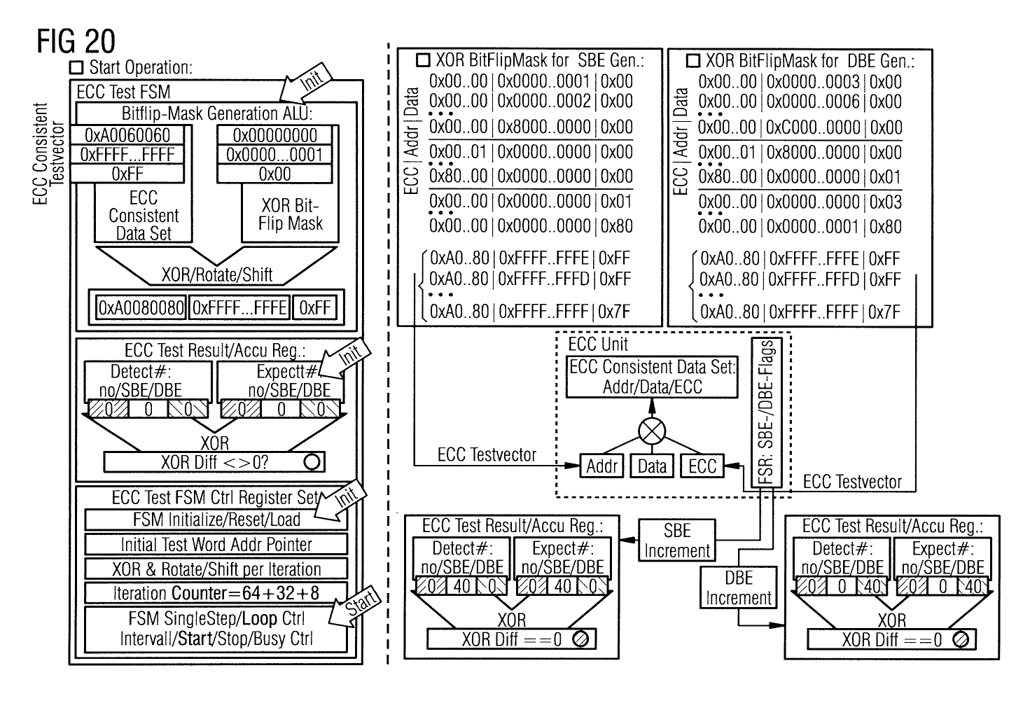

FIG. 20 illustrates a still further example according to another embodiment.

Embodiments exhibit further various benefits of the ECC FSM (FSM=Finite State Machine) test engine.

An open customer test feature for error-correction-code functionality tests of safety aspects during run time is realized. Embodiments are applicable to all error-correction-code correctable memories (not restricted to flash).

No knowledge about error-correction-code consistent data set construction is necessary.

According to embodiments, error-correction-code unit testing is possible on the same path and with the same logic as at memory read-out.

In embodiments, no definition of a forced fail pattern signature for RAM/eFlash is needed.

According to embodiments, no exact definition of address location and sequence of a forced fail pattern generation is needed.

Embodiments are based on the following findings:

Forced fails are employed to check whether error correction works.

Non-volatile memories, for example, flash, are of particular interest. Flash memory may be suitable for double-programming. Regarding error-correction-code, for example 64 user data bits may be accompanied by 8 correction data bits.

When double programming, for example the first programming and the second programming result may be connected by a logical bit-wise OR.

The CPU tests whether the error correction code (ECC) works. S-runs may, for example, be tested. For example, airbag applications are of particular interest. It has to be found out whether an error-correction-code unit is erroneous. The error correction code may deteriorate over time. Tests may for example either be initialized by a user or automatically started.

It may, for example, be programmable that for example only a single cell is tested or that more cells are tested.

Typically, a memory may have a single error-correction-code unit for testing the memory.

Tests may usually only be conducted during idle times.

An initialization of the address starter and of the error correction code may be necessary.

Pseudorandom tests may be conducted.

As already stated, application fields may, for example, be the automotive industry.

According to an embodiment, error correction is conducted by determining whether a flag indicates whether error correction was conducted. The number of flags may be counted, wherein the number of flags indicates the number of error corrections that have been conducted. Then it is tested whether the number of conducted error corrections is equal to the number of expected error corrections.

In another embodiment, whenever error correction is conducted, it is tested whether the corrected bits are equal to the expected bits.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

Regarding the claim set, the disclosure also covers any conceivable combination of claims.

1. A circuitry for error-correcting data and for checking a correctness of an error-correction capability of an error-correction component of the circuitry, wherein the circuitry comprises:
an input interface for receiving an input data word,
a data manipulator for manipulating one or more bits of a test data word to obtain a modified data word, wherein said test data word is said input data word or is derived from said input data word,
said error-correction component for processing the modified data word, and
an evaluation component for evaluating the correctness of the error-correction capability of the error-correction component depending on the processing of the modified data word by the error-correction component.

2. The circuitry according to claim 1,
wherein the error-correction component is configured to check and to indicate by flagging, whether the modified data word is erroneous, and
wherein the evaluation component is configured to evaluate the correctness of the error-correction capability of the error-correction component depending on the outcome of the check, conducted by the error-correction component, whether the modified data word is erroneous.

3. The circuitry according to claim 1,
wherein the error-correction component is configured to check whether the modified data word is erroneous, and
wherein, if the error-correction component has determined that the modified data word is erroneous, the error-correction component is configured to correct the modified data word to obtain a corrected data word,
wherein the evaluation component is configured to determine, whether the corrected data word is equal to an expected data word, and
wherein, if the corrected data word is different from the expected data word, the evaluation component is configured to determine that the error-correction capability of the error-correction component is incorrect.

4. The circuitry according to claim 1,
wherein the error-correction component is configured to check whether the modified data word is erroneous,
wherein, if the error-correction component has determined that the modified data word is erroneous, the error-correction component is configured to correct the modified data word to obtain a corrected data word comprising user data bits and error-correction bits,
wherein the evaluation component is configured to determine depending on the user data bits of the corrected data word and depending on the error-correction bits of the corrected data word, whether the corrected data word is erroneous, and
wherein, if the corrected data word is erroneous, the evaluation component is configured to determine that the error-correction capability of the error-correction component is incorrect.

5. The circuitry according to claim 1,
wherein the error-correction component is arranged to receive the input data word from the input interface,
wherein the error-correction component is configured to check,
whether the input data word is erroneous,
wherein, if the error-correction component determines that the input data word is erroneous, the error-correction component is configured to correct the input data word to obtain a precorrected data word and is configured to feed the precorrected data word as said test data word into the data manipulator, and
wherein, if the error-correction component determines that the input data word is not erroneous, the error-correction component is configured to feed the input data word as said test data word into the data manipulator.

6. The circuitry according to claim 1,
wherein the circuitry further comprises a mode switcher for activating a normal operation mode,
wherein, if the normal operation mode is activated, the mode switcher is configured to deactivate the data manipulator and the evaluator, so that, when the normal operation mode is activated, the data manipulator is configured to not manipulate said one or more bits of said test data word, and so that, when the normal operation mode is activated, said evaluation component is configured to not evaluate the correctness of the error-correction capability of the error-correction component.

7. The circuitry according to claim 1,
wherein the circuitry further comprises a user interface being configured to enable a user to specify one or more bits of the test data word that shall be manipulated, and
wherein the data manipulator is configured to manipulate said one or more bits of the test data word that have been specified by the user via the user interface.

8. The circuitry according to claim 1,
wherein the test data word comprises user data bits and error-correction bits for error-correction,
wherein the data manipulator is configured to manipulate at least one bit of the error-correction bits of the test data word.

9. The circuitry according to claim 8,
wherein the circuitry further comprises a user interface being configured to enable a user to specify said at least one bit of the error-correction bits of the test data word, and
wherein the data manipulator is configured to manipulate said at least one bit of the error-correction bits of the test data word that has been specified by the user via the user interface.

10. The circuitry according to claim 8,
wherein the test data word comprises the user data bits and the error-correction bits, and address bits for specifying a location of the user data bits within a memory,
wherein the data manipulator is configured to manipulate at least one bit of the address bits of the test data word.

11. The circuitry according to claim 10,
wherein the circuitry further comprises a user interface being configured to enable a user to specify said at least one bit of the address bits of the test data word, and
wherein the data manipulator is configured to manipulate said at least one bit of the address bits of the test data word that has been specified by the user via the user interface.

12. The circuitry according to claim 1,
wherein the circuitry furthermore comprises a memory, and
wherein the input interface is configured to load the input data word from the memory.

13. The circuitry according to claim 10,
wherein the circuitry furthermore comprises a memory, and
wherein the input interface is configured to load the input data word from said memory.

14. The circuitry according to claim 12, wherein said memory is a flash memory.

15. The circuitry according to claim 1, wherein the evaluation unit is configured to deactivate the circuitry or to output an alarm or alarm message, if the evaluation component has detected that the error-correction of the error-correction component is incorrect.

16. The circuitry according to claim 1,
wherein the data manipulator is configured generate two or more modified data words, said modified data word being one of the two or more data words, so that each modified data word of the two or more modified data words is different from each other modified data word of the two or more modified data words,
wherein the data manipulator is configured to generate each of the two or more modified data words by modifying at least one bit of the test data word,
wherein, for each modified data word of the two or more modified data words, the error-correction component is configured check whether said modified data word is erroneous, and
wherein the evaluation component is configured to evaluate the correctness of the error-correction capability of the error-correction component depending on the outcome of the checking of the two or more modified data words.

17. The circuitry according to claim 16,
wherein the evaluation component is configured to determine an erroneous words number indicating how many modified data words of the two or more modified data words the error-correction component assesses to be erroneous, and
wherein the evaluation component is configured to determine whether said erroneous words number is equal to an expected error number indicating how many of the two or more modified data words are actually erroneous.

18. The circuitry according to claim 16, wherein the data manipulator is configured to generate each of the two or more modified data words by modifying exactly one bit of the test data word.

19. The circuitry according to claim 16, wherein the data manipulator is configured to generate each of the two or more modified data words by modifying exactly two bits of the test data word.

20. The circuitry according to claim 16,
wherein the data manipulator comprises an XOR circuit element, a further circuit element, and a bit register,
wherein the bit register comprises a bit for each bit position of the test data word,
wherein the bit register is configured, so that each bit in the bit register, being assigned to a bit position of the test data word, that is to be inverted to generate a first modified data word of the two or more modified data words, exhibits a first bit value in the bit register, and
wherein the bit register is configured, so that each bit in the bit register, being assigned to a bit position of the test data word, that is not to be inverted to generate the first modified data word, exhibits a second bit value in the bit register, said second bit value being different from the first bit value,
wherein the XOR circuit element is arranged to receive the test data word as a first input,
wherein the XOR circuit element is arranged to receive the bit values of the bits in the bit register as an initial second input to generate the first modified data word of the two or more modified data words,
wherein the further circuit element is configured to shift or rotate the bit values of the bits within the bit register by one bit position after the first modified data word has been generated to obtain updated bit values of the bits within the bit register, and
wherein the XOR circuit element is arranged to receive the updated bit values of the bits within the bit register as an updated second input to generate a second modified data word of the two or more modified data words.

21. A method for error-correcting data and for checking a correctness of an error-correction capability of an error-correction component, wherein the method comprises:
receiving by an input interface an input data word,
manipulating by a data manipulator one or more bits of a test data word to obtain a modified data word, wherein said test data word is said input data word or is derived from said input data word,
processing the modified data word by said error-correction component, and
evaluating by an evaluation component the correctness of the error-correction capability of the error-correction component depending on the processing of the modified data word by the error-correction component.

22. A computer program for implementing the method of claim 21 when being executed on a computer or signal processor.
